(19) United States
(12) Patent Application Publication
(10) Pub. No.: US 2016/0275269 A1
(43) Pub. Date: Sep. 22, 2016

(54) METHODS FOR CENTRAL MONITORING OF RESEARCH TRIALS

(71) Applicant: International Drug Development Institute, Louvain-La-Neuve (BE)

(72) Inventors: Marc Buyse, Genval (BE); Tomasz Burzykowski, Hasselt (BE); David Venet, Brussels (BE); Erik Doffagne, Wavre (BE)

(21) Appl. No.: 15/076,346

(22) Filed: Mar. 21, 2016

Related U.S. Application Data
(60) Provisional application No. 62/135,806, filed on Mar. 20, 2015.

(51) Int. Cl. G06F 19/00

(52) U.S. Cl. CPC G06F 19/363

(57) ABSTRACT

A method for central monitoring of a research trial utilizing a plurality of distributed data collection centers includes creating and storing a database consisting of datasets generated during the research trial. Statistical tests are executed in the network on a data collection center by data collection center basis to detect abnormalities and patterns present in datasets of the statistical database. A matrix containing p-values based upon the executed statistical tests is created and stored in the network. The matrix has as many rows as there are data collection centers and as many columns as executed statistical tests. Any outlying data collection centers are identified by summarizing the p-values. Data Inconsistency Score (DIS) is created for each collection center.

### CROSS REFERENCE TO RELATED APPLICATIONS

This application claims the benefit of the filing date of U.S. Provisional Patent Application Ser. No. 62/135,806 titled “Methods for Central Monitoring of Research Trials” and filed Mar. 20, 2015.

### FIELD OF THE INVENTION

This specification is directed, in general, to methods and systems for analyzing data from clinical trials, and more particularly to improved methods and systems for detecting and presenting inconsistent clinical trials data using statistical methods.

### BACKGROUND OF THE INVENTION

Over the decade of 2001-2010, clinical research costs have sky-rocketed while new drug approvals have decreased by one third. At the current pace of increase in costs, adequately sized clinical trials may become infeasible. Alternatively, such costs will have to be reflected in the price of new drugs, which will eventually cause an intolerable burden on health care systems.

In view of typical trial costs, different options have been suggested to reduce some of these costs without compromising the scientific validity of the trials. The greatest potential savings lie in the labor-intensive activities such as on-site monitoring, which can represent as much as 30% of the total budget in large global clinical trials. It is therefore not surprising that the current practice of performing intensive on-site monitoring is coming into question. A draft guidance of the U.S. Food and Drug Administration (FDA) states unequivocally: “FDA encourages greater reliance on centralized monitoring practices than has been the case historically, with correspondingly less emphasis on on-site monitoring”.

For various reasons, the trial may encounter problems. For example, the investigators may not always comply with the trial protocol while conducting the trial. In another example, an investigator may fail to administer the medical therapy correctly. In yet another example, an investigator may fabricate results.

Accordingly, it would be advantageous to provide visual representations of the clinical trials data inconsistencies that enable a wider range of users to identify the cause or causes of such inconsistencies.

### SUMMARY OF THE INVENTION

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, a method for central monitoring of a research trial utilizing a plurality of distributed data collection centers is described in which an illustrated embodiment includes creating and storing a database consisting of datasets generated during the research trial. Statistical tests are executed in the network on a data collection center by data collection center basis to detect abnormalities and patterns present in datasets of the statistical database. A matrix containing p-values based upon the executed statistical tests is created and stored in the network. The matrix has as many rows as there are data collection centers and as many columns as executed statistical tests. Any outlying data collection centers are identified by summarizing the p-values. Data Inconsistency Score (DIS) is created for each center k, using a formula such as:

DISₖ=−log(scₖ)

where scₖ is an overall p-value score of center k.

It should be appreciated that the subject technology can be implemented and utilized in numerous ways, including without limitation as a process, an apparatus, a system, a device, a method for applications now known and later developed or a computer readable medium. These and other unique features of the methods and systems disclosed herein will become more readily apparent from the following description and the accompanying drawings.

### BRIEF DESCRIPTION OF THE DRAWINGS

So that those having ordinary skill in the art to which the disclosed methods and systems appertain will more readily understand how to make and use the same, reference may be had to the following drawings.

FIG. 1 is a diagram showing a distributed computing environment for utilizing centralized statistical monitoring of research trials in accordance with the subject disclosure.

FIG. 2 is a flow diagram of a process performed by the central monitoring system of FIG. 1.

FIG. 3 is a process of report generation in accordance with the subject disclosure.

FIG. 4 is an example table with details on statistical tests for a given data collection center in accordance with the subject disclosure.

FIG. 5 is an example of a graphical output generated by the central monitoring system in accordance with the subject disclosure.

FIG. 6 is an example of an individual factor map obtained from the Principal Component Analysis (PCA) in accordance with the subject technology.

FIG. 7 is a flow diagram of a process performed by a statistical analysis system as may be implemented in FIG. 1.

FIG. 8 is a control dashboard presented on a computer screen in accordance with the subject technology.

FIG. 9 is an exemplary bubble plot in accordance with the subject technology.

FIG. 10 is an exemplary center profile plot in accordance with the subject technology.

FIG. 11 is an exemplary extreme p-value plot in accordance with the subject technology.

FIG. 12 is exemplary patient data in accordance with the subject technology.

FIG. 13 is a screenshot presenting signal and issue identification in accordance with the subject technology.

FIG. 14 is a screenshot presenting action tracking in accordance with the subject technology.

FIG. 15 is a screenshot presenting the setup of key risk indicators (KRI) in accordance with the subject technology.

FIG. 16 is a screenshot presenting the KRI dashboard in accordance with the subject technology.

### DETAILED DESCRIPTION OF CERTAIN EMBODIMENTS

The subject technology overcomes many of the prior art problems associated with research trials that collect large volumes of data and need to have the data verified in a cost-effective manner. The advantages, and other features of the methods and systems disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

Clinical trial sponsors are required to set up appropriate measures to monitor the conduct of their trials. One of the aims of monitoring is to ensure data accuracy and completeness. The most common method used to verify data quality is through Source Data Verification (SDV) during on-site monitoring visits. SDV consists of comparing information recorded in the Case Report Form (CRF) with the corresponding source documents. Such manual verification is extremely costly, and its contribution to data quality has been questioned.

Extensive monitoring with 100% SDV is undesirable, even in regulatory trials, and reduced monitoring, which consists of controlling only a random sample of data, is much more cost-effective. The random sampling of reduced monitoring can be performed at various levels: country; centers within countries; patients within centers; visits within patients; CRF pages within visits; and the like.

Reduced monitoring may be adapted to the risk associated with the experimental procedure. For example, a trial involving innocuous procedures or well-known treatments could involve less monitoring than a trial involving invasive procedures or experimental new drugs.

Another option is “targeted” monitoring, (also known as “adaptive” or “triggered” monitoring), where the intensity and frequency of on-site monitoring is triggered by key performance or risk indicators. These indicators typically focus on critical aspects of trial conduct such as: accrual performance (e.g., actual accrual rate compared with projected accrual rate, accrual patterns over time); protocol adherence (e.g., percentage of protocol deviations, percentage of dropouts); treatment compliance (e.g., percentage of dose reductions or delays); safety reporting (e.g., percentage of adverse events and serious adverse events reported); and data management (e.g., percentage of overdue forms, query rate, query resolution time).

On-site monitoring is useful to prevent or detect procedural errors in the trial conduct at data collection centers. Central statistical monitoring is useful to detect data errors, whether due to faulty equipment, negligence or fraud. Central monitoring can be based on key performance or risk indicators, or on statistical methods.

The following describes utilization of statistical methods to conduct central monitoring. Central statistical monitoring utilizes the highly structured nature of clinical data, since the same protocol is implemented identically in all data collection centers, using the same CRF. Hence, the same hierarchical data structure is used throughout the trial, with variables or items grouped by CRF page (or screen when electronic data capture is used), CRF pages or screens grouped by visit, visits grouped by patient, patients grouped by investigator, investigators grouped by center, centers grouped by country, and countries grouped by geographical area or continent.

When the trial is randomized, the group allocated by randomization provides another design variable that allows for specific statistical tests to be performed, because baseline variables are not expected to differ between the randomized groups (but through the play of chance), while outcome variables are expected to differ about equally in all centers (but through the play of chance) if the treatments under investigation have a true effect. Abnormal trends and patterns in the data can be detected by comparing the distribution of all variables in each center against all other centers. Such comparisons can be performed either one variable at a time in a univariate fashion or with several variables, taking into account the multivariate structure of the data, or using longitudinal data when the variable is repeatedly measured over time.

Statistical data checks are especially useful because the multivariate structure and/or time dependence of variables are very sensitive to deviations in the case of errors and hard to mimic in the case of fraud. Fabricated or falsified data, even if plausible univariately, are likely to exhibit abnormal multivariate patterns that are detectable statistically. In addition, humans are poor random number generators, and are generally forgetful of natural constraints in the data; hence tests on randomness of the data can detect invented data. Every piece of information collected in the CRF during the conduct of the trial, and every variable coded in the clinical database is potentially indicative of data quality, not just those associated with a set of indicators predefined to reflect site performance in terms of data quality (KRIs). A statistical approach therefore requires a large number of statistical tests to be performed. These tests generate a high-dimensional matrix of p-values representing the probability to draw a center more extreme than the center observed, which can be analyzed by statistical methods and bio-informatics tools to identify outlying centers. The matrix has as many rows as there are data collection centers and as many columns as executed statistical tests.

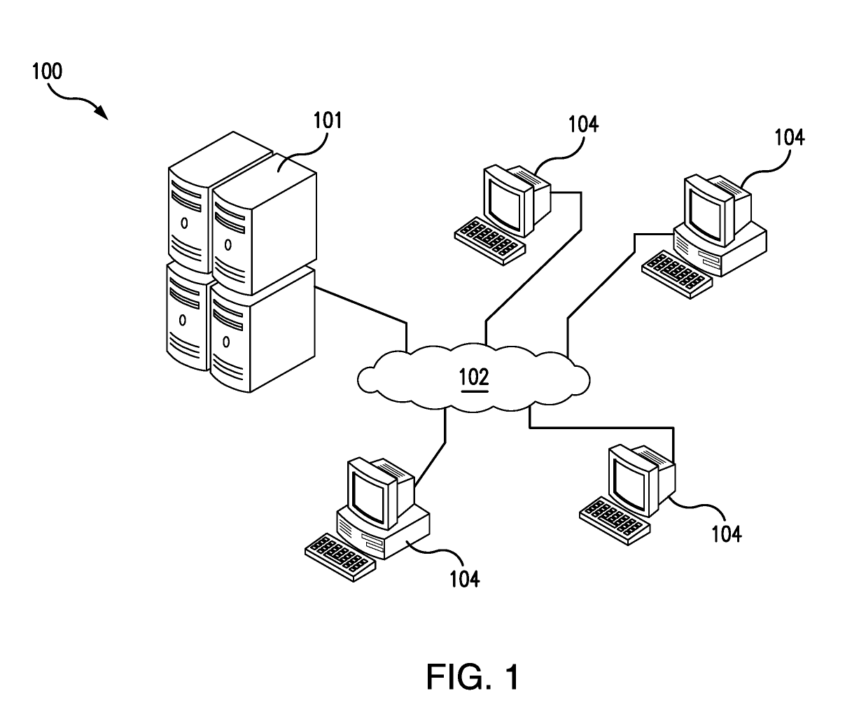

Referring now to the FIG. 1, there is shown a block diagram of an environment 100 with central monitoring of research trials embodying and implementing the methodology of the present disclosure. The present technology allows users, who gather data from trial participants, to enter data. The following discussion describes the structure of such an environment 100 but further discussion of the application programs and data that embody the methodology of the present invention is described elsewhere herein.

The environment 100 includes one or more servers 101 which communicate with a distributed computer network 102 via communication channels, whether wired or wireless, as is well known to those of ordinary skill in the pertinent art. In a preferred embodiment, the distributed computer network 102 is the Internet. For simplicity, although a plurality of servers 101 are shown, the term server 101 applies well to the grouping as such computing power is well-known to be aggregated. Server 101 hosts multiple Web sites and houses multiple databases necessary for the proper operation of the central monitoring methods in accordance with the subject invention.

The server 101 is any of a number of servers known to those skilled in the art that are intended to be operably connected to a network so as to operably link to a plurality of clients or user computers 104 via the distributed computer network 102. The plurality of computers or clients 104 may be desktop computers, laptop computers, personal digital assistants, tablet computers, scanner devices, cellular telephones and the like. The clients 104 allow users to enter and access information on the server 101. For simplicity, only four clients 104 are shown but the number is unlimited. The clients 104 have displays and an input device(s) as would be appreciated by those of ordinary skill in the pertinent art.

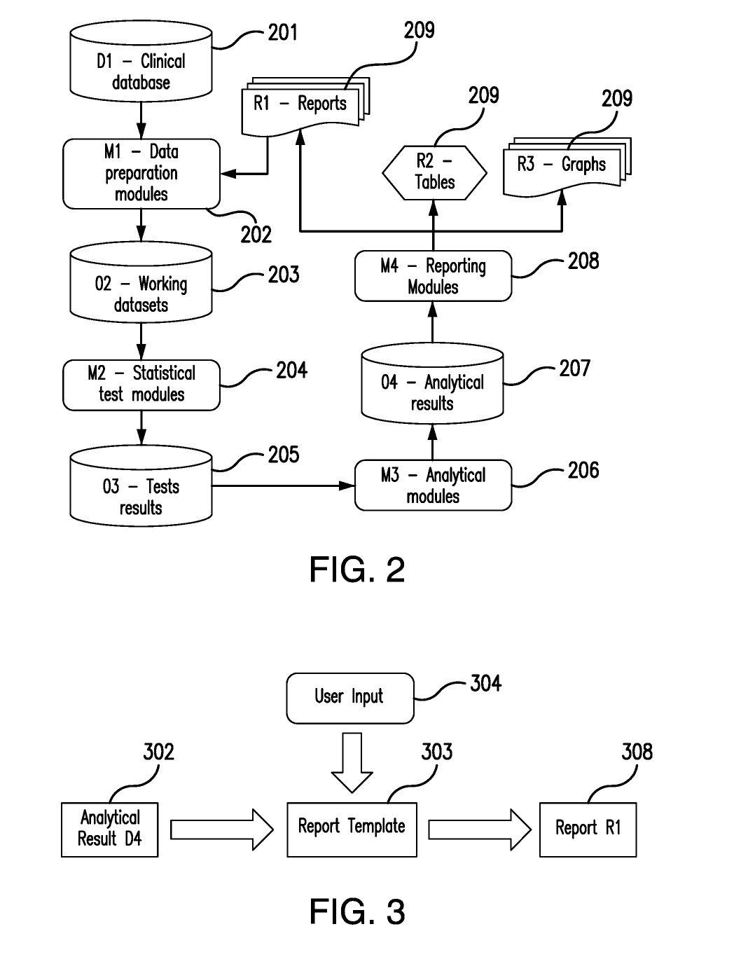

The flow charts herein illustrate the structure or the logic of the present technology, possibly as embodied in computer program software for execution on a computer, digital processor or microprocessor in the environment 100. Those skilled in the art will appreciate that the flow charts illustrate the structures of the computer program code elements, including logic circuits on an integrated circuit, that function according to the present technology. As such, the present technology may be practiced by a machine component that renders the program code elements in a form that instructs a digital processing apparatus (e.g., computer) to perform a sequence of functional steps similar to or corresponding to those shown in the flow charts. Before turning to description of FIG. 2, it is noted that the flow diagram in FIG. 2 shows examples in which functional steps are carried out in a particular order, as indicated by the lines connecting the blocks, but the various steps shown in these diagrams can be performed in any order, or in any combination or sub-combination. It should be appreciated that in some embodiments some of the steps described below may be combined into a single step. In some embodiments, one or more steps may be omitted. In some embodiments, one or more additional steps may be performed.

Referring now to FIG. 2, there is illustrated a flowchart depicting a process for facilitating the central monitoring methods in accordance with an embodiment of the present technology. In a preferred embodiment, a company (not shown) hosts a Web site to provide access for research trial practitioners to utilize the environment 100 for central monitoring. The environment 100 also provides for administration and security maintenance. Therefore, although each user (e.g., data managers, statisticians, monitors, sponsors, etc.) of the subject technology has access to a user interface on a client 104, each group's access is controlled. The interface specifies which aspects of the program can be accessed, and at what level in order to maintain compliance with technical electronic data interchange standards and legal confidentiality restraints such as HIPAA (Health Insurance Portability and Accountability Act) and quality standards such as GCP (Good Clinical Practice), if the invention is used to monitor clinical trials of new drugs, biologicals or medical devices. Such limitations of functionality are well known to those skilled in the art and therefore not further described herein.

The flowchart of FIG. 2 also includes portions of the architecture to support the successive processing steps of the subject methodology. The architecture includes three types of system components or architecture where business logic modules are denoted by the letter “M”, data components are denoted by the letter “D”, and results are denoted by the letter “R” to help more clearly illustrate how the various components operate and interact.

At step 201, a database D1 is created and stored for use in the central monitoring method or process. In clinical trials, the database is typically provided by the sponsor of the trial as a snapshot of the clinical database in SAS® format. In such cases, the clinical database D1 consists of a set of SAS® data files in SAS7BDAT format. The clinical data may be scattered in several datasets that relate to portions of the CRF or other grouping criterion. As used herein, the term “dataset” refers to data in tabular form where the columns correspond to the variables and the rows correspond to the observations.

At step 202, a data preparation module M1 imports data from the clinical database D1 and performs preprocessing, extracts metadata, and creates working datasets D2, which are stored at step 203. In one embodiment, the user specifies the subject identifier, center identifier, visit number and some other parameters like the name of technical variables that are removed.

The preprocessing that may be performed in step 202 consists of the removal of variables that are not suitable for the analysis. Such variables may be variables for which all observations are missing, for which all observations have the same value, for which the number of observations is too small (e.g., less than 5 patients) or variables that have been explicitly specified by the user as not relevant (i.e. technical variables).

According to an embodiment of the present invention, step 202 may further involve the extraction of metadata, which may include the derivation of number of visits per patient, creation of the list of patients per center. Further, metadata are created to identify the type of each variable, duplicate variables (e.g. same variable available coded as character and as numeric), and variables that are replicated (information that is collected more than once per patient).

At step 203, the working datasets D2 are generated which include a collection of preprocessed datasets and the associated metadata obtained in step 202. The working datasets are stored in a format compatible with the statistical tests performed by statistical test modules M2 in step 204.

The statistical test modules M2 then perform step 204 of executing statistical tests. The role of the statistical tests is to detect abnormalities and patterns present in the datasets and more globally to assess the overall data quality and center performance. Each statistical test compares each center to the other centers, for each variable. Preferably, all statistical tests conceptually follow the same pattern of calculating an aggregate number for each center (e.g., the mean or standard deviation of a variable). Each center is then compared to all other centers using the aggregate numbers. A probability can be given to each center, which is the probability to draw a center more extreme than the center observed. A different statistical model is fitted for each variable, so that the variable's distributional properties (e.g., variance) are properly taken into account.

As part of step 205, the results from the statistical tests performed by the statistical test modules M3 are stored in a Test Results database D3. The results consist of a matrix containing the p-values. The p-value matrix has as many rows as there are centers and as many columns as tests performed. Additional information may be kept in the Test Results database D3 such as, but not limited to aggregate numbers used for the statistical tests and information on the statistical models used (i.e., model fitted, estimated parameters, etc).

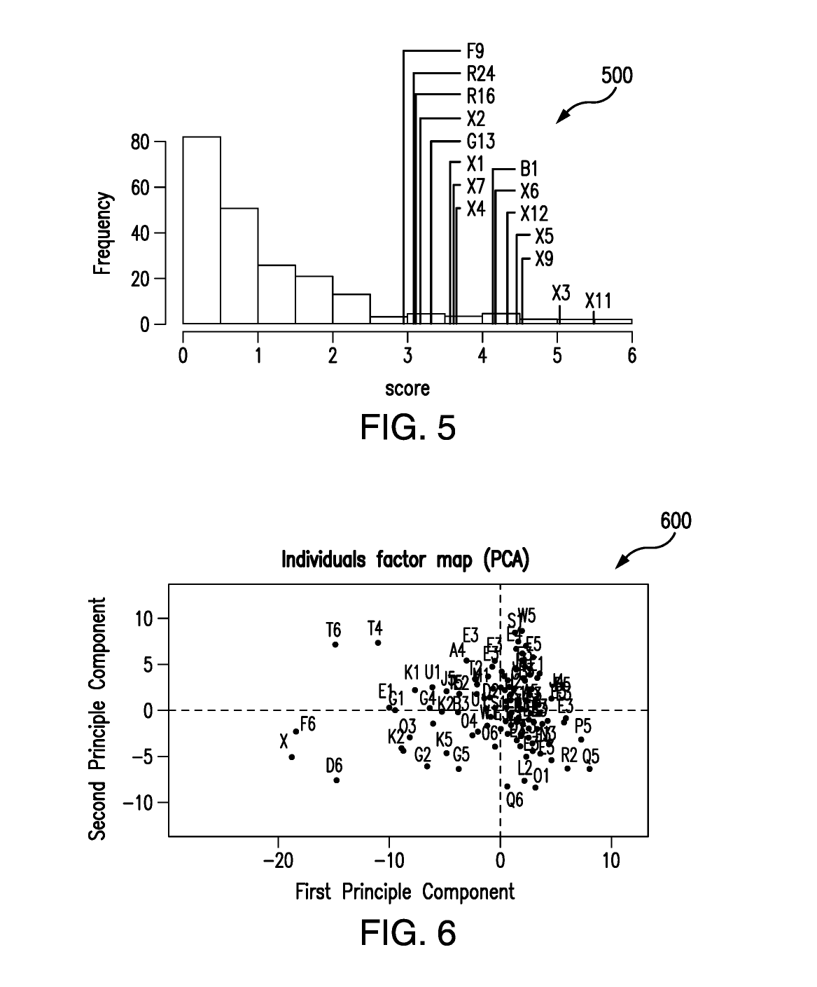

At step 206, the analytical module M3 processes the test results stored in the Test Results database D3. In one embodiment, the analytical module M3 summarizes the large amount of p-values that have been generated by the statistical test module M2 in order to identify outlying centers. In one embodiment, two techniques are both implemented to perform the center ranking: a Principal Component Analysis (PCA) and a score method described below. Both of these methods utilize the tests result matrix obtained from M2. The two methods are complementary and provide different graphical representations of the results, as shown in FIGS. 5 and 6. The method for calculating the scores is described below.

The scoring implemented in the analytical module M3 starts by removing the non-informative tests, then the p-value matrix is preprocessed and finally the p-value score is computed.

The removal of non informative tests improves the performance of embodiments of the present invention by reducing the amount of noise. The non-informative tests can grouped in three categories. The first category is tests with too many missing p-values. Tests for which the proportion of missing p-values exceeds the threshold of m % are removed. The second category is tests with too many significant results. In this category tests that have more than a given percentage, such as 10% of p-values below 10⁻², are excluded. The third category includes the tests with too few significant results. In this category, tests that have no p-value below the minimal p-value expected after Bonferroni correction are excluded.

The preprocessing step is aimed to avoid overweighting the analysis by extreme p-values. All p-values smaller than a given threshold t such as 10⁻¹⁰ are set to the threshold.

It should be noted that the different statistical tests look at different characteristics of the data. Considering all tests together gives more weight to tests that have been performed more frequently than others. To avoid this problem, according to an embodiment of the present invention, five categories of tests may be defined: (1) tests on values, 2) tests on dates; (3) tests on digits preference; (4) tests on underreporting, such as, for example, tests on missing values and on count of records; and (5) multivariate tests, such as tests on multivariate inliers and outliers. Tests in the first category look at distribution characteristics such as, for example, the mean or the standard deviation (proportion of tests on categorical variables also fall into this category), wherein the tests on values include tests on repeated measurements for variables measured several times in the trial.

Six scores are computed: one overall p-value score; and five sub-scores (one for each category of tests described above). The p-value score scₖ for the center k is computed as a weighted average of the p-values of the executed statistical tests, using a formula such as:

$${sc}_{k} = exp ( \frac{1}{{qN}_{k}} {\sum }_{i = 1}^{{qN}_{k}} log ( {p}_{ik} ) )$$

where Nₖ is the number of tests performed for center k, pᵢₖ are the sorted p-values for center k, and q is a value between 0 and 1. The role of the quantile q is to perform the calculation only on the most significant p-values. It is useful to specify q<1 when the number of tests is large. The p-value score scₖ as defined above takes values between 0 and 1.

At step 207, the results from the Analytical Modules M3 are stored in the Analytical results database D4. The Analytical Results database D4 consist of the analytical results obtained from the PCA and the p-value scores computed for the different categories defined in step 206.

At step 208, based on the data stored in the Analytical results database D4, the Reporting modules M4 enable the creation of reports R1, tables R2 and graphs R3 that can be used for interpretation in step 209. The Reporting Modules M4 can generate two types of tables, spreadsheet tables and report tables. In one embodiment, the Reporting Module M4 has a built-in facility that enables semi-automatic generation of the report R1.

Referring now to FIG. 3, the process for generating a report is shown schematically. At step 302, the user calls the reporting function to generate analysis and a template file. At step 303, the template file contains all standard report sections, some of the tables R2 (described below) and some of the graphs R3 (described below). At step 304, the user edits the template file to add his or her interpretation in plain words before the report R1 is generated at step 308.

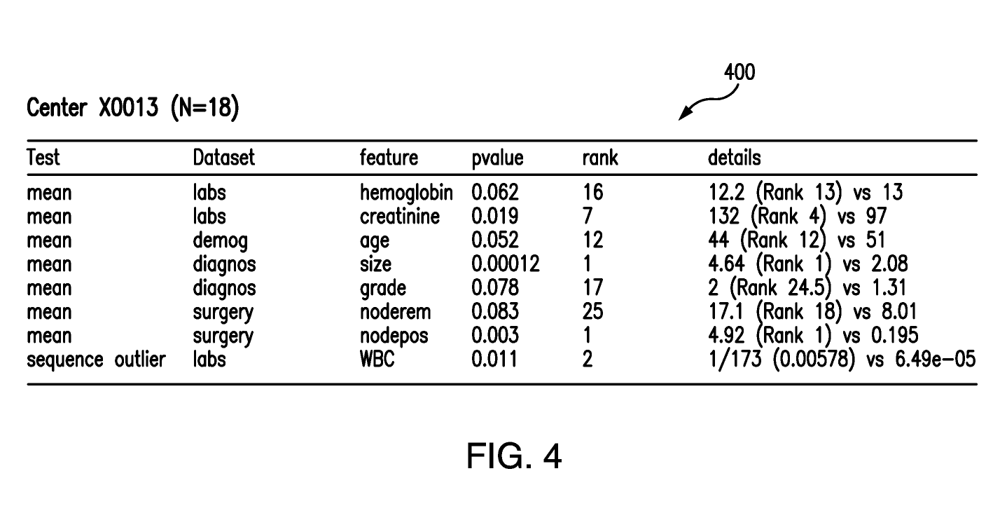

In one embodiment, the Reporting Modules M4 generate two sets of tables R2. One type of table contains the p-value matrix. As noted above, in the p-value matrix table, the columns are the tests and the rows the centers. The centers are sorted according to the rank of their p-value score so the top centers on the table are the most outlying. A second type of table is a summary table 400, as shown in FIG. 4. The summary tables 400 are produced for each center providing detailed information about the abnormalities detected by the system and methods disclosed herein. The summary tables 400 include the statistical tests results and show the aggregate number (i.e., mean, variance) for the center against the pooled aggregate numbers for all other centers. The summary tables 400 enable the user to interpret the abnormalities and to pinpoint potentially problematic data.

In one embodiment, the Reporting Modules M4 generate two sets of graphs R3. One type of graph 500, a frequency distribution of p-value scores, is shown in FIG. 5. In the graph 500 of FIG. 5, centers that have a high p-value score are shown by a labeled vertical line. These centers are likely to contain problematic data. A second type of graph 600 illustrates an individual factor map obtained from the PCA as shown in FIG. 6. In the graph 600 of FIG. 6, each center is identified by a labeled point. Centers far from the origin behave differently from the bulk of centers around the origin and are likely to contain problematic data.

Central statistical monitoring can reveal data issues that had remained undiscovered after careful SDV and on-site checks. These data issues may in turn point to other problems, such as lack of resources or poor training at the data collection centers concerned, which would call for corrective actions. Central statistical monitoring allows highlighting problems, such as a lack of variability in blood pressure measurements or implausible values in a questionnaire, which would not have been detected by key risk indicator methods. This is because the former approach compares centers on all possible variables, while the latter approach focuses on specific, pre-defined variables of particular relevance to data quality. Targeted monitoring differs from central statistical monitoring in that it relies on KRIs, the drawbacks of such an approach being the programming required for every new study, and the fact that not all data are exploited. In contrast, central statistical monitoring as described in this disclosure takes advantage of all the data and requires no trial-specific programming.

In view of the above, once the central statistical monitoring is complete, a database of results is created. Preferably, the databases are stored in the servers 101 of the environment 100 of FIG. 1. For example, such as in FIG. 2 above, at step 205, the results from the statistical test modules M3 are stored in a Test Results database D3. The Test Results database D3 can be analyzed and interpreted.

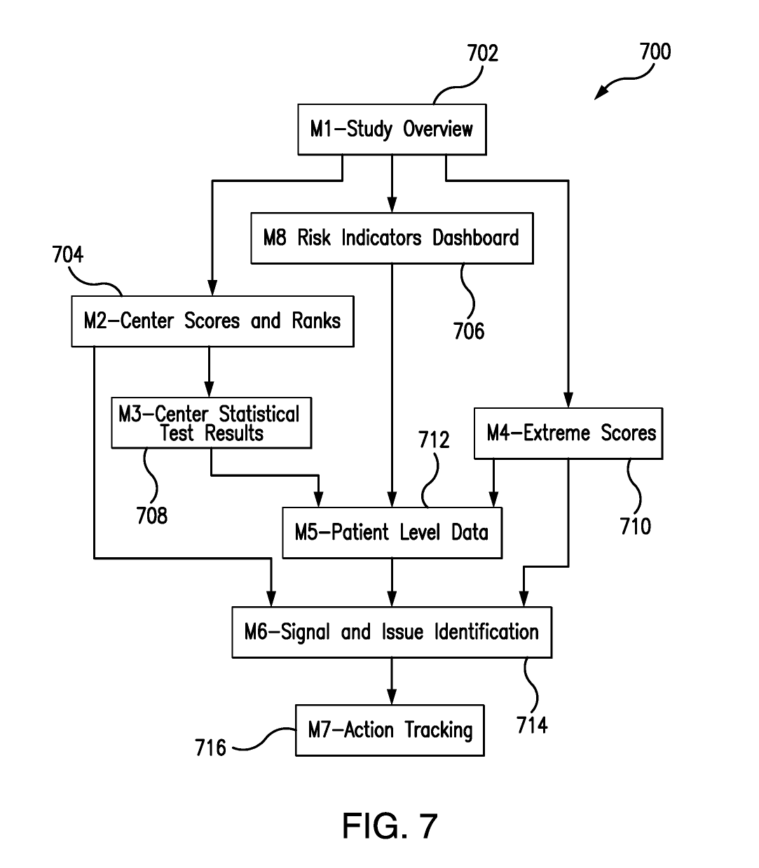

Referring now to FIG. 7, a statistical analysis system 700 for analyzing and interpreting a database of results such as the Test Results database D3 is shown. The statistical analysis system 700 may be implemented in the environment 100 of FIG. 1. Typically, the statistical analysis system 700 is a software program housed in memory of the servers 101 for execution by the server microprocessors and accessed by the computers 104 over the network 102. The software program presents a graphical user interface so that the user can navigate computer screens to utilize the statistical analysis system 700 and associated methods to benefit from the subject technology.

One benefit of the statistical analysis system 700 is to detect data inconsistencies among the various data collection centers participating in the research. The statistical analysis system 700 allows users to evaluate, explore and interpret the results of the statistical tests and the center scoring described herein. The statistical analysis system 700 includes several modules M1-M8 that are interconnected.

The “Study Overview” module (M1) 702 acts as an entry point to provide an overview of all statistical tests carried out for each study, as described below.

From the “Study Overview” module 702, the user can access the “Center Scores and Ranks” module (M2) 704. The “Center Scores and Ranks” module 704 is a visualization module that shows the center scores and ranks computed by the central monitoring system of FIG. 1. From the “Center Scores and Ranks” module 704, the user can access the “Center Statistical Test Results” module (M3) 708 to understand why a particular center is atypical. Preferably, by drilling down to the “Center Statistical Test Results” module 708, the user has access to all test results for each center.

Also, from the “Study Overview” module 702, the user can access the “Extreme Scores” module (M4) 710, which shows all extreme p-values across all centers. In various embodiments, the definition of “extreme” is chosen by the user and generally depends, in particular, on the total number of statistical tests performed for a given research trial. Specifically, a reasonable threshold might be 10⁻⁵ divided by the total number of tests performed. Such a threshold will often be considered too conservative, in which case it can be relaxed so that more statistical tests are shown as “extreme”. In addition, from the “Study Overview” module 702, the user can access the “Risk Indicators Dashboard” module (M8) 706, using which the user can define risk indicators based on a specified dataset, variable and statistical test. From either of the “Risk Indicators Dashboard” module 706, “Center Statistical Test Results” module 708 or the “Extreme Scores” module 710, the user can access more details on specific variables for which atypical patterns were detected by using the “Patient Data” module (M5) 712. The “Patient Data” module 712 allows the user to browse patient level data.

From the “Center Scores and Ranks” module 704, the “Extreme Scores” module 710 or the “Patient Data” module 712, multiple test results can be grouped together and labeled as a signal by using the “Signal and Issue Identification” module (M6) 714. A signal could be associated, for example, with a description “Underreporting of Adverse Events” and would contain statistical tests related to the dataset Adverse Events. The “Signal and Issue Identification” module 714 also enables the user to flag a single signal, or a set of related signals, as being an issue.

From the “Signal and Issue Identification” module 714, the user can access the “Actions Tracking” module (M7) 716. The “Actions Tracking” module 716 allows tracking corrective actions triggered by detected issues.

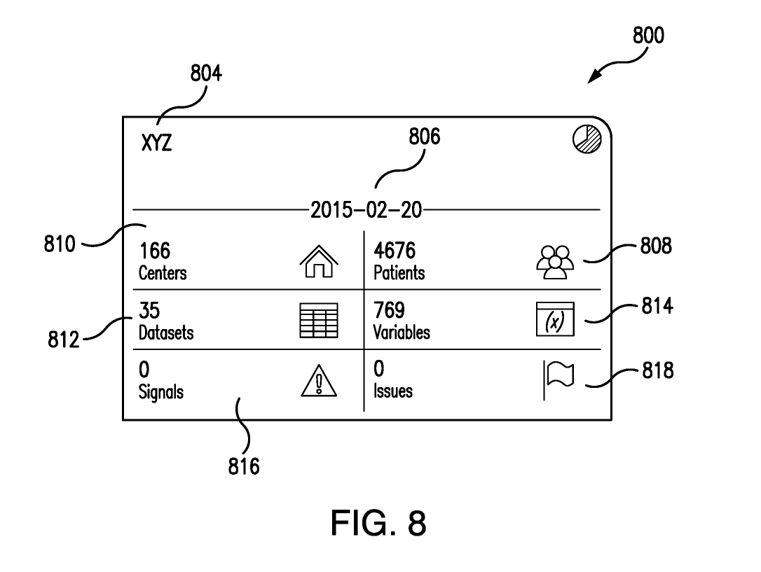

Referring now to FIG. 8, the user uses the “Study Overview” module 702 to review a control dashboard 800. The control dashboard 800 presents summary information on the study analyzed. In the illustrated embodiment shown in FIG. 8, a name area 804 shows the study is called “XYZ.” The summary information also includes a date area 806, a number of patients area 808, a number of centers area 810, a number of datasets area 812, and a variables area 814. Additionally, the summary information includes a signals area 816 and an issues flagged area 818. In various embodiments, the issues may be flagged by the analyst manually or identified by the statistical analysis system by comparison to predetermined rules.

On the control dashboard 800, the user can also see a list of the analyses performed on the study database, which typically comprise an analysis of all variables, an analysis of pre-defined “critical” variables, and an analysis of all variables except laboratory values and other centrally collected variables (such as electrocardiograms and imaging data). Critical variables may include, but are not limited to, adverse events, screening failures, inclusion criteria, and other variables that capture important aspects of the trial conduct.

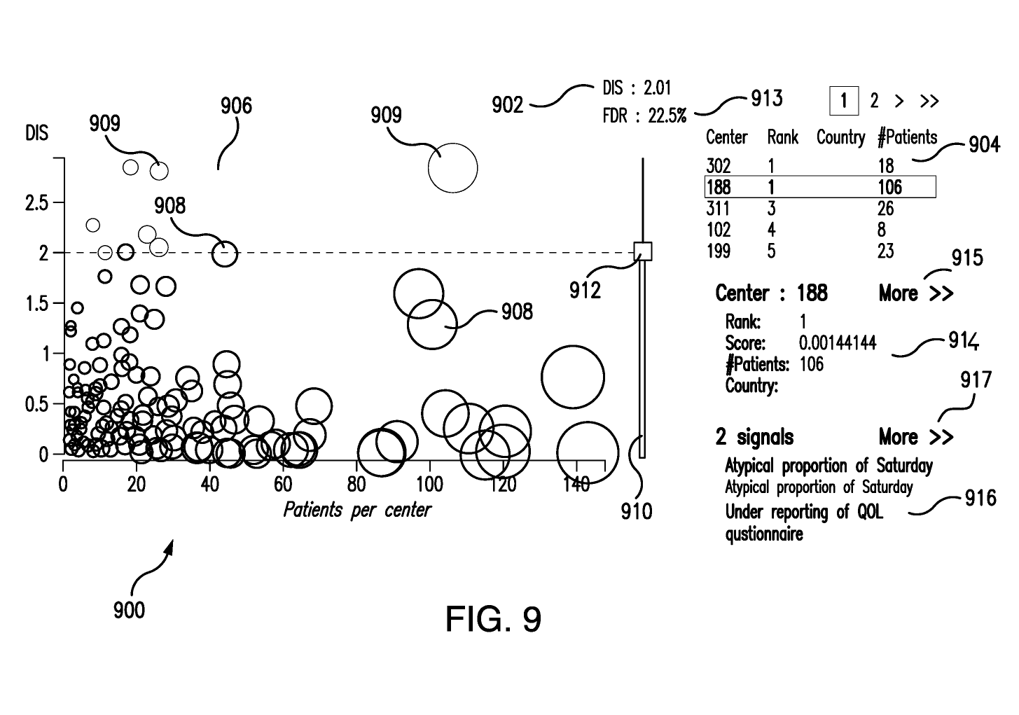

The “Center Scores and Ranks” module 704 allows the user to directly identify outlying centers for each analysis performed on the study. Referring now to FIG. 9, an exemplary bubble plot 900 in accordance with embodiments of the present invention is shown. The “Center Scores and Ranks” module 704 creates the bubble plot 900 including a “Data Inconsistency Score (DIS)” score area 902. The data inconsistency score of exemplary center k is calculated by the formula:

DISₖ=−log(scₖ)

where scₖ is the overall p-value score of center k, preferably calculated as described above.

The bubble plot 900 has a graph area 906 with the DIS on the vertical axis and the number of patients on the horizontal axis. Each center is represented by a bubble 908-909 (for clarity only several bubbles are labeled in FIG. 9). The size of the bubbles 908-909 is proportional to the number of subjects in that center. It is envisioned that the bubbles 908-909 can be various colors to indicate one or more particular parameters. For example, bubbles 909 can be shown in different color to identify centers that are outlying (i.e., have inconsistent data) at a given level of statistical significance.

Still referring to FIG. 9, the bubble plot 900 has a ranking area 904, which shows descriptive information on the centers having the highest DIS. The descriptive information can include: the center number; the center rank; the country or other geographic area in which the center is located; and the number of patients.

The bubble plot 900 also presents a user-adjustable False Discovery Rate (FDR) area 913, which identifies the probability that a center has been detected as an outlier when in fact it is not. The user can modify the FDR for a selected center by clicking on a square 912 shown on an FDR slider 910, and sliding up or down as desired. The smaller the FDR, the more confident the user can be that a center identified as outlying is truly an outlier.

The user can also drill down into the statistical tests of any center of interest by clicking on the bubble 908 representing that center. The statistical test data area 914 presents the corresponding data for the selected center: the center rank (rank “1” corresponding to the center with the most outlying data), the center score, the number of patients in the center, and the center country. The user can ask for more information on the center by clicking on the “More>>” button 915. The signals area 916 presents a description of the signals found in the center as described herein further. The user can ask for more information on the signals by clicking on the “More>>” button 917.

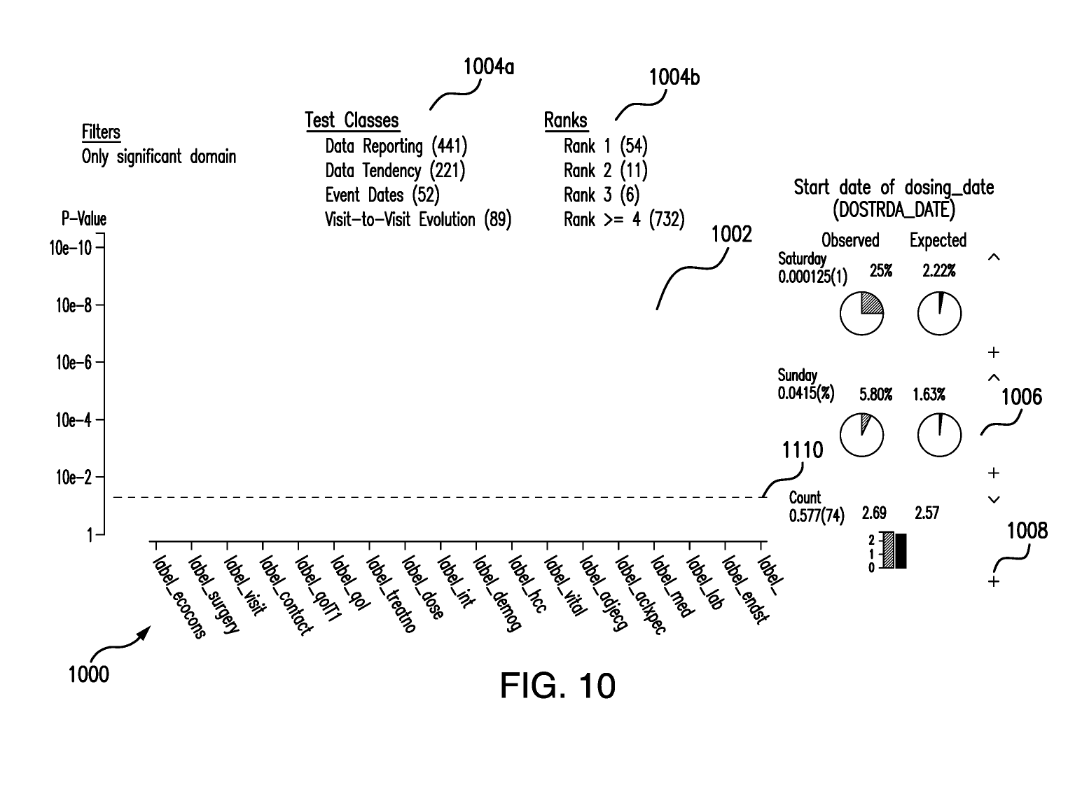

Referring now to FIG. 10, an exemplary center profile plot 1000 is shown. The “Center Statistical Test Results” module 708 creates the center profile plot 1000. A main graph area 1002 of the center profile plot 1000 has a graph with a vertical axis showing, for each center, a negative logarithm of the p-values of all the statistical tests carried out on the data from the respective center, with tests grouped by “domain” along the horizontal axis as explained below.

Each symbol in the main graph area 1002 corresponds to a statistical test. Legend areas 1004a, 1004b include symbols that indicate the test classes and ranks, respectively. In one embodiment, shapes can be used to indicate different test classes and color can be used to indicate the rank assigned to each center for a particular test. For example, red can be for rank 1, yellow for rank 2, blue for rank 3, and green for ranks 4 or greater. These symbols in the main graph area 1002 are shown in gray if the symbol falls under the horizontal line 1110 corresponding to a p-value equal to 0.05. The symbol's shape, as shown in legend area 1004a, indicates the type of statistical test performed. For example, a circle can be used to represent tests related to reporting issues (e.g., missing values), a diamond to represent tests related to tendency (e.g., means, variances, etc.), a clover to represent tests related to dates (e.g., patient visits on weekend dates), a triangle to represent tests related to longitudinal measures (e.g., evolution over successive patient visits) and the like.

Statistical tests can also be grouped by “domain”, a domain being a set of data collected on a patient at a specific time using a specific data collection instrument (e.g., demographic information, vital signs, adverse events, laboratory values, etc.). When the user browses over a particular symbol, the statistical analysis system highlights all other statistical test results performed on the same variable. By clicking on a particular test, the statistical analysis system presents the patient level data upon which this test was calculated in patient data area 1006. Area 1006 shows descriptive statistics on the data in the center for which the test was calculated (labelled “Observed”) as compared with the data in all other centers (labeled “Expected”).

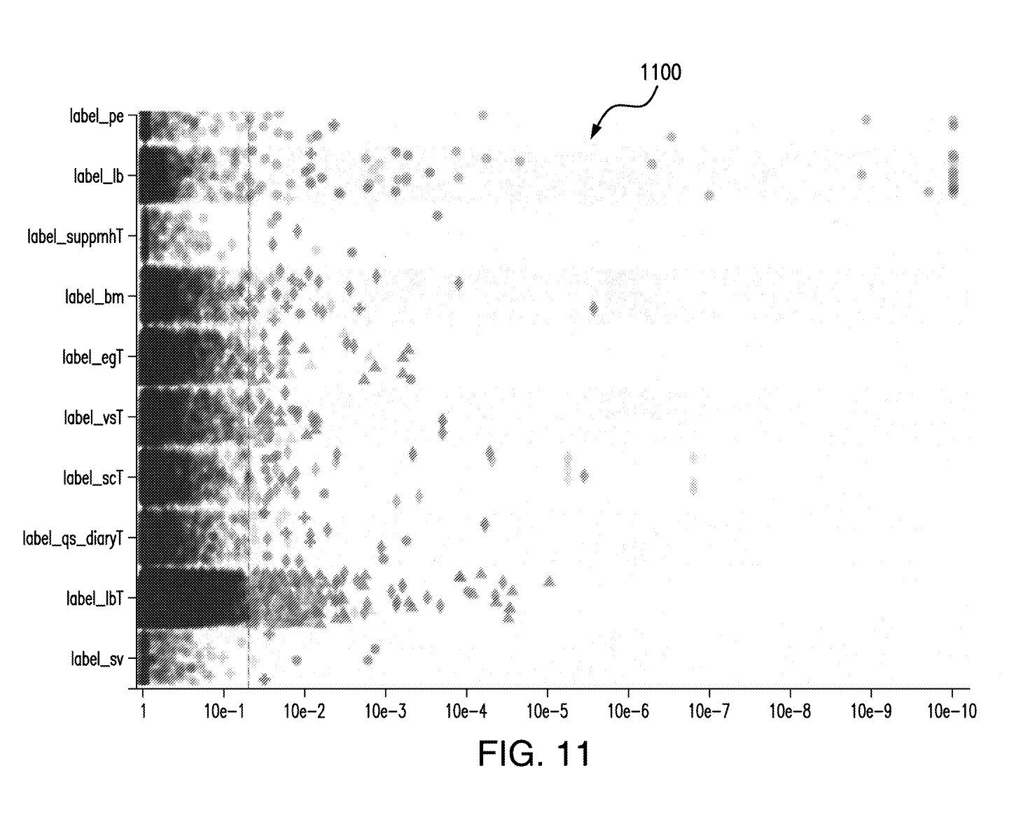

Referring now to FIG. 11, an exemplary extreme p-value plot 1100 as produced by the “Extreme Scores” module 710 in accordance with an embodiment of the present invention. The extreme p-value plot 1100 presents the statistical test results for all centers at once. The plot 1100 of the extreme p-values has a vertical axis showing domains (similar to the horizontal axis in FIG. 10) and a horizontal axis showing the negative logarithm of the p-values of all the statistical tests carried out on the data from the respective center, with tests grouped by “domain” (similar to the horizontal axis in FIG. 10).The statistical test results are grouped by domain to facilitate a quick identification of problem areas. This visualization is useful to identify centers that have not been picked by their overall score but that have at least one test with an extreme P-value that may require further investigation. The interpretation of the shapes and colors of the symbols of FIG. 11 is identical to that of FIG. 10.

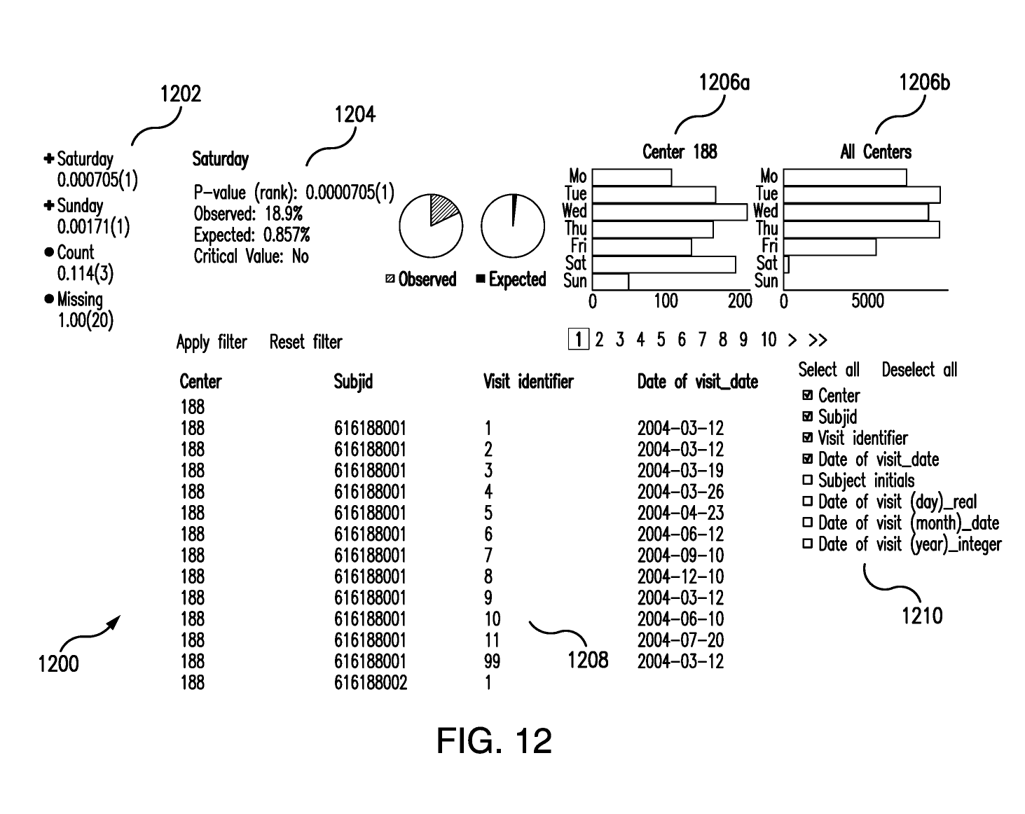

FIG. 12 is an exemplary patient data screenshot 1200 in accordance with an embodiment of the present invention. By accessing the patient data screenshot 1200, the user can drill down to the level of patient data in order to visualize the individual values of the variable that was used in the corresponding statistical test. The patient data screenshot 1200 includes an area 1202 that shows the name of the test from which the user drilled down. A specific area 1204 includes pie charts of observed and expected results along with p-value, rank, observed percentage, expected percentage, and a critical value result. The patient data screenshot 1200 includes areas 1206a, 1206b that show descriptive statistics for the data in the center and in all other centers. Visit area 1208 presents data for a plurality of individual visits at a particular center in a table format. In various embodiments, the format of the visit area 1208 depends on the type of variable(s) selected in check box area 1210. Additionally, when the user browses over an element in the visit area 1208, the related values of the variable are highlighted in the patient level data table.

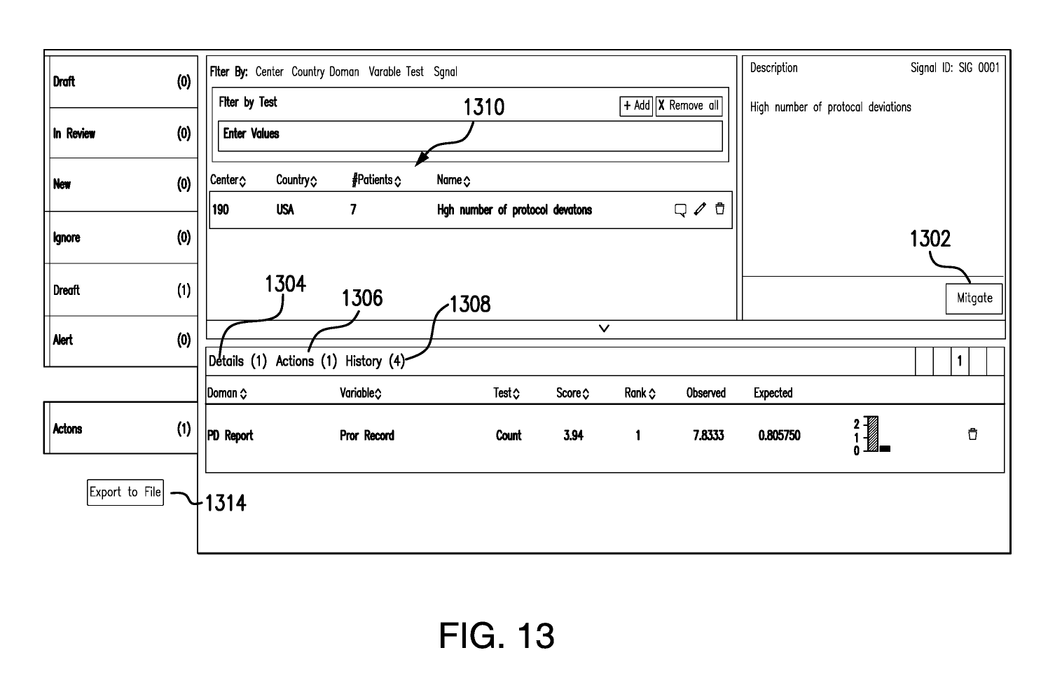

Referring now to FIG. 13, a signal and issue identification screenshot 1300 as produced by the “Signal and Issue Identification” module 714 is shown. After investigation of the statistical test results of a center, the signal and issue identification screenshot 1300 allows the user to create “signals” that encompass one or more statistical test results. A term “signal” as used herein refers to a collection of statistical test results, possibly consisting of a single statistical test. Each signal may be given a short title and a long description; the user may add all relevant statistical tests to the signal by clicking on the “+” icon 1008 at the bottom right of the panel in area 1006 for the corresponding test in FIG. 10. The user may press button 1302 to mitigate the signal by categorizing it into “Ignore”, “Watch” or “Alert”, for example. The “Ignore” category may be used for signals that are not relevant from an operational or clinical perspective. The “Watch” category may correspond to signals that require to be followed. The “Alert” category may be used for signals that represent a substantial risk for the clinical trial and that require actions to be taken immediately. To allow the user to navigate between details, actions and history associated with a particular signal, the signal and issue identification screenshot 1300 displays corresponding tabs 1304, 1306 and 1308. In the signal summary area 1310 various signal identifying information may be presented such as, but not limited to, center identifier, geographic location and number of patients, as well as the description of the corresponding signal. Advantageously, the signal and issue identification screenshot 1300 enables the user to export results to a file using any suitable format, for example, by pressing button 1314.

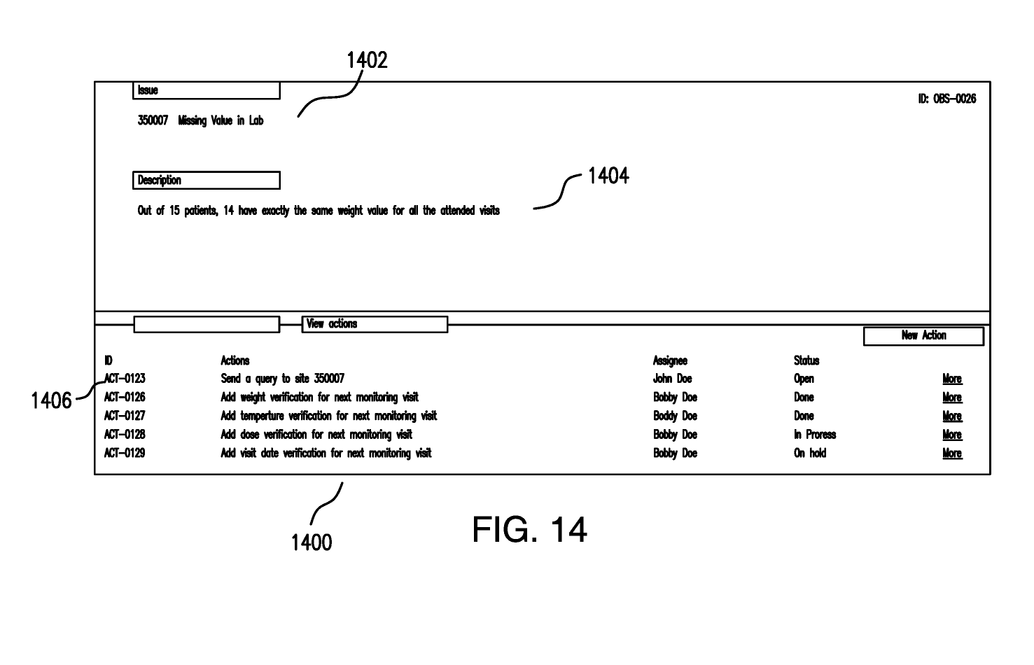

Referring now to FIG. 14, an action tracking screenshot 1400 as created by the “Action Tracking” module 716 is shown. The action tracking screenshot 1400 is customized to be specific to a user-selected issue identified in a specific center. The action tracking screenshot 1400 includes an issue area 1402 to identify the issue, a description area 1404 to present a description of the selected issue, and an action area 1406 to list the actions corresponding to the issues. All actions taken to investigate or address the issue can be tracked using the same screen. In one embodiment, the actions may be time stamped for future reference.

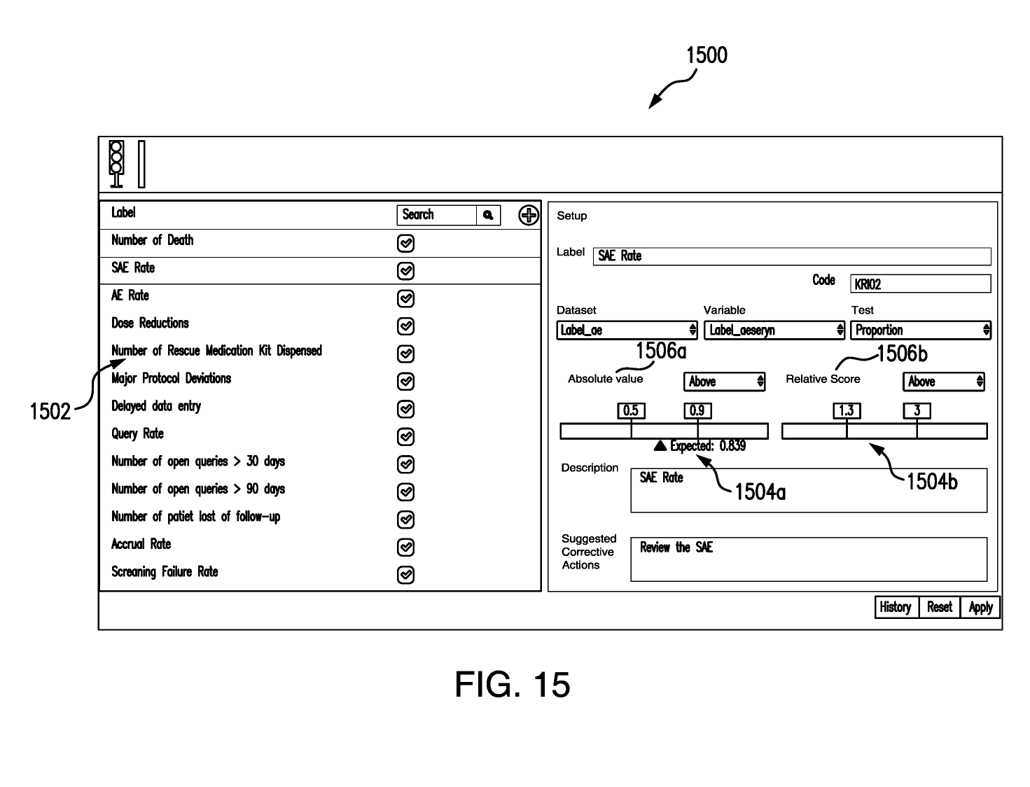

FIG. 15 illustrates is a screenshot for presenting the setup of KRIs created by the “Risk Indicator Dashboard” 706. The user can use the KRI setup screen 1500 to define risk indicators 1502 based on a specified dataset, variable and statistical test. The user can configure the thresholds 1504a and 1504b for Medium and High risk in relation to the Absolute Value 1506a and the Relative Score 1506b, respectively. In one embodiment, the Absolute Value 1506a is a summary statistic such as the mean or a count and therefore the applicable thresholds 1504a are dependent on the nature of the indicator. The Relative Score 1506b corresponds to the p-value obtained by the statistical test, which is a probability that does not depend on the scale or unit of the indicator.

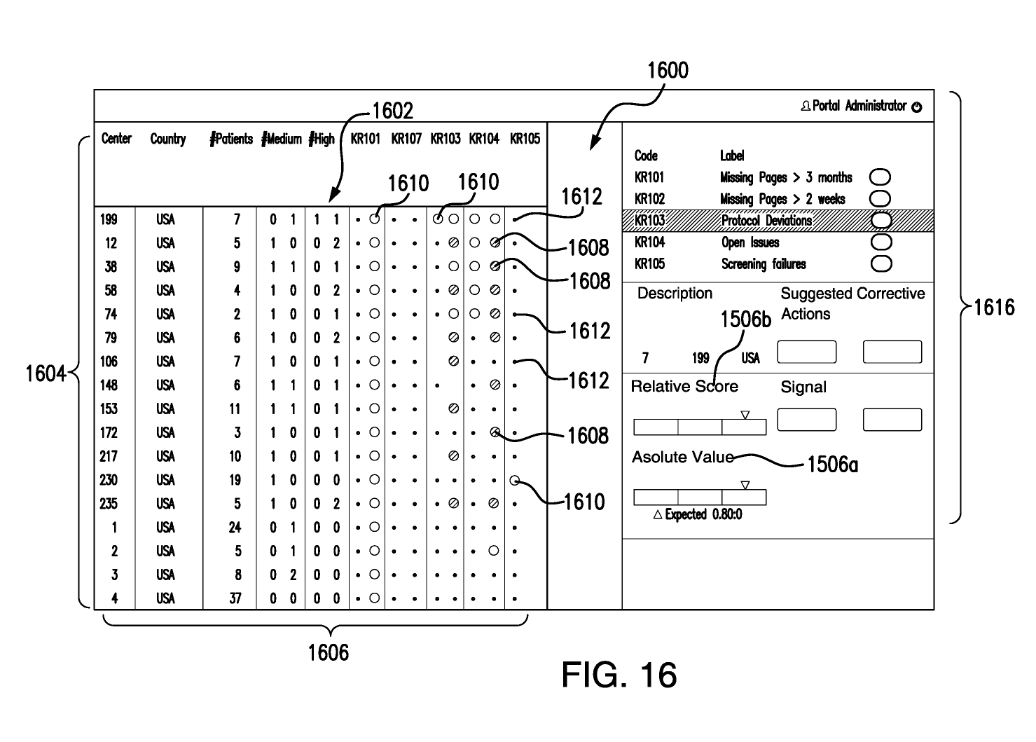

FIG. 16 shows how KRI results are displayed for the user. The dashboard 1600 contains a table 1602 with rows 1604 corresponding to the centers and columns 1606 corresponding to the Risk Indicators. The Risk Indicators are displayed as color-coded circles 1608-1612. In one embodiment, red circles 1608 can be used to represent high risk, yellow circles 1610 to represent medium risk and green circles 1612 to represent low risk. In one embodiment size of the circles 1608-1612 is indicative of risk levels. In other words, the size of the circles 1608-1612 increases as the risk level increases. At least in some embodiment, the Absolute Value 1506a and/or the Relative Score 1506b may be displayed in the area shown in the right part of the screen 1616. For example, when the user selects a cell, the right part of the screen 1616 may provide additional information about the center selected and allows the user to drill down to “Patient Level Data” module 712.

In summary, FIGS. 8 to 16 illustrate a user-friendly interface enabling the users to explore the results of the data monitoring analyses, to create “signals” based on the results of the statistical tests performed, and “issues” that require actions to be taken to improve the quality and integrity of the data collected in the research trial.

While the invention has been described with respect to preferred embodiments, those skilled in the art will readily appreciate that various changes and/or modifications can be made to the invention without departing from the spirit or scope of the invention. For example, each claim may depend from any or all claims, even in a multiple dependent manner, even though such has not been originally claimed. And, each step, module and component may be removed or rearranged in any sequence or combination.

What is claimed is:

1. A method for conducting a research trial utilizing a plurality of distributed data collection centers, the method comprising the steps of:
creating and storing a database consisting of datasets generated during the research trial, wherein each dataset includes a center and corresponding center data;
executing statistical tests, by a processor, on a data collection center by data collection center basis to detect abnormalities and patterns present in datasets of the statistical database;
creating and storing, by a processor, a matrix containing p-values based upon the executed statistical tests, wherein the matrix has as many rows as there are data collection centers and as many columns as executed statistical tests;
identifying, by a processor, any outlying data collection centers by summarizing the p-values; and
generating, by a processor, Data Inconsistency Score (DIS) for each center.

2. The method of claim 1, further comprising the step of presenting, to a user over a network, a bubble plot having DIS on a vertical axis and a number of patients per center on a horizontal axis, with each center represented by a bubble, wherein the size of each bubble is proportional to the number of patients in that center.

3. The method of claim 2, further comprising the step of determining if datasets for any centers are inconsistent, wherein the bubbles are red for a corresponding center if the datasets of the center are inconsistent.

4. The method of claim 2, further comprising the step of calculating and presenting, over the network, a False Discovery Rate (FDR) based on the datasets.

5. The method of claim 1, further comprising the step of presenting, to a user over a network, a center profile plot having a negative logarithm of the p-values of all statistical tests carried out on the data from a center on a vertical axis and a plurality of tests grouped by domain along a horizontal axis.

6. The method of claim 1, further comprising the step of presenting, to a user over a network, a center profile plot having a negative logarithm of the p-values of all statistical tests carried out on the data from a center on a vertical axis and a plurality of tests grouped by domain along a horizontal axis, wherein the center profile plot presents a plurality of graphical symbols.

7. The method of claim 6, wherein each of the plurality of graphical symbols corresponds to a performed statistical test.

8. The method of claim 7, wherein shapes of the graphical symbols indicate different test classes and colors of the graphical symbols indicate the rank assigned to each center for a particular test.

9. The method of claim 1, further comprising the step of presenting, to a user over a network, an extreme p-value plot, wherein the extreme p-value plot presents statistical test results for all test centers at once.

10. The method of claim 9, wherein the statistical test results are grouped by domain.

11. The method of claim 1, further comprising the step of presenting, to a user over a network, patient data, wherein the patient data includes at least one of charts of observed and expected results, p-value rank, observed percentage, expected percentage, and a critical value result.

12. The method of claim 11, wherein the patient data includes data for a plurality of individual patient visits at a particular center presented in a table format.

13. The method of claim 1, further comprising the step of generating one or more signals, each signal comprising one or more user-selected statistical tests.

14. The method of claim 13, further comprising the step of categorizing the one or more generated signals according to user-specified criteria.

15. The method of claim 1, further comprising the step of generating Key Risk Indicators (KRIs), wherein each KRI is generated based on a dataset, variable and statistical test specified by a user.

16. The method of claim 15, further comprising the step of presenting the KRIs as color-coded circles to a user.

17. The method of claim 1, further comprising the steps of:
preprocessing, by the network, the database to remove variables that are unsuitable for analysis;
extracting, by the network, metadata from the database to identify types of the variables;
storing, in the network, the preprocessed datasets and corresponding metadata in a statistical database that is in a format compatible for analysis;
determining if any of the executed statistical tests are faulty and removing such faulty executed statistical tests from the matrix to create a filtered matrix; and
computing an overall p-value score according to:
$${sc}_{k} = exp ( \frac{1}{{qN}_{k}} {\sum }_{i = 1}^{{qN}_{k}} log ( {p}_{ik} ) )$$
where Nₖ is the number of tests performed for center k, pᵢₖ are the sorted p-values for center k, and q is a value between 0 and 1.

18. A method for central monitoring of a research trial utilizing a plurality of distributed data collection centers, the method comprising the steps of:
storing a clinical database in a network, wherein the clinical database includes a matrix containing p-values based upon statistical tests executed at the plurality of distributed data collection centers, and wherein the matrix has an many rows as there are distributed data collection centers and as many columns as there are executed statistical tests;
computing an overall p-value score for each distributed data collection center based on the p-values for the respective distributed data collection center; and
identifying at least one outlying data collection center based upon the overall p-values.

19. A computer system for conducting a research trial utilizing a plurality of distributed data collection centers, the computer system comprising:
a database storing a plurality of datasets generated during the research trial, wherein each dataset includes a center and corresponding center data;
one or more processors;
one or more computer-readable storage devices;
and a plurality of program instructions stored on at least one of the one or more storage devices for execution by at least one of the one or more processors, the plurality of program instructions comprising:
program instructions to execute statistical tests to detect abnormalities and patterns present in datasets of the statistical database;
program instructions to create and store a matrix containing p-values based upon the executed statistical tests, wherein the matrix has as many rows as there are data collection centers and as many columns as executed statistical tests;
program instructions to identify any outlying data collection centers by summarizing the p-values; and
program instructions to create a Data Inconsistency Score (DIS) for each center.

20. The computer system of claim 19, further comprising the program instructions to present to a user a bubble plot having DIS on a vertical axis and a number of patients per center on a horizontal axis, with each center represented by a bubble, wherein the size of each bubble is proportional to the number of patients in that center.
